(19) United States
(12) Patent Application Publication
(10) Pub. No.: US 2022/0052410 A1
(43) Pub. Date: Feb. 17, 2022

(54) BATTERY HOUSING AND USE THEREOF

(71) Applicant: ThyssenKrupp Steel Europe AG, Duisburg (DE)

(72) Inventors: Jennifer SCHULZ, Unna (DE); Erik HILFRICH, Dusseldorf (DE)

(73) Assignee: ThyssenKrupp Steel Europe AG, Duisburg (DE)

(21) Appl. No.: 17/312,201

(22) PCT Filed: Dec. 10, 2019
(86) PCT No.: PCT/EP2019/084385

§ 371 Date: Jun. 9, 2021

(30) Foreign Application Priority Data
Dec. 13, 2018 (DE) 10 2018 132 171.6

(51) Int. Cl. H01M 50/249; H01M 50/224; H01M 50/231

(52) U.S. Cl. CPC H01M 50/249; H01M 50/224; B60L 50/64; H01M 2220/20; H01M 50/231

(57) ABSTRACT

The present invention relates to a battery housing for receiving one or more battery modules, in particular for an electrically powered vehicle or a vehicle having a hybrid drive, comprising a box having a frame and a base, which provides an interior space for receiving the battery module or modules, at least one mounting support which is connected at least in certain portions, on that side of the frame which faces away from the interior space, to the frame of the box and which serves for the releasable connection of the battery housing to a vehicle, and a cover for closing the box, wherein the frame, the base, the mounting support or the cover of the battery housing is manufactured from a steel sheet which has a microstructure comprising ferrite and martensite and which is provided with a zinc-based coat on one or both sides.

### TECHNICAL FIELD

The present invention relates to a battery housing for receiving one or more battery modules, in particular for an electrically powered vehicle or a vehicle having a hybrid drive, comprising a box having a frame and a base, which provides an interior space for receiving the battery module or modules, at least one mounting support which is connected at least in certain portions, on that side of the frame which faces away from the interior space, to the frame of the box and which serves for the releasable connection of the battery housing to a vehicle, a cover for closing the box.

### TECHNICAL BACKGROUND

The increasing or continuing electrification of vehicles, in particular of automobiles, and the simultaneous desire of consumers for long ranges of such vehicles, requires the development of high-performance battery concepts. In particular, battery housings, which receive the battery modules or in which the battery modules are received, generally have a substantial extent in the vehicle longitudinal and transverse directions and are usually mounted centrally, in particular below the passenger compartment under the vehicle (floor panel). The battery housing is used, inter alia, to protect the battery modules against damage and to dissipate the heat generated by the battery modules while the vehicle is being driven. This results in complex requirements in respect of the factors of installation space, crash performance, weight, tightness, etc.

The battery housing has to protect the battery modules against water and therefore has to be water-tight. The requirements demand a tightness typically up to a water depth of 1 m. Below the vehicle (floor panel), the battery housing is exposed to spray water which may also be provided with road salt. To this end, the battery housing has to be protected against being rusted through.

In order to be able to produce battery housings economically and with a high degree of crash safety, said housings are preferably produced from ultra-high-strength steel. By way of example, DE 10 2016 110 330 A1 discloses a battery housing constructed in the generic manner from a plurality of steel parts, and also the mounting or fastening of the battery housing to a vehicle using releasable connecting means, preferably using screws.

The steel used should be coatable and weldable. The steel used, preferably coated steel, or the components manufactured therefrom are, inter alia, connected to one another via weld seams to form an interior space of a battery housing for receiving battery modules, wherein the intention is to ensure that the weld seams seal the interior space and thus are tight. There is a conflict of objectives here because corrosion protection coatings with high protective action can reduce the process reliability in the case of the welding or the welded connection. Furthermore, the steel used should also have a certain amount of deformation resistance in order to satisfy the necessary requirements in the case of a crash.

### SUMMARY OF THE INVENTION

The invention is based on the object of providing a battery housing, in particular for an electrically powered vehicle or a vehicle having a hybrid drive, said battery housing having a water-tight and corrosion-resistant design and in particular having a high deformation resistance.

This object is achieved by a battery housing having the features of patent claim 1.

The component parts of the battery housing such as for example the frame, the base, the mounting support or the cover of the battery housing are manufactured from metal. According to the invention, at least one of the component parts (frame, base, mounting support, cover) is manufactured from a steel sheet which has a microstructure comprising ferrite and martensite and which is provided with a zinc-based coat on one or both sides. The combination of ferrite and martensite confers a high deformation resistance paired with a very good coating suitability on the respective component part. The production of steel sheets having corresponding microstructures or properties is known in the prior art and the technical field. According to the invention, the steel sheet has a microstructure comprising at least 65% of ferrite and martensite, wherein there is at least 20% of ferrite and at least 5% of martensite, wherein up to 35% of bainite, pearlite, cementite and/or residual austenite can be present.

s a result of the setting of martensite, it is clear that the steel sheets used for manufacturing the respective component part are subjected only to a cold-forming operation or a temperature-controlled forming operation, during which no microstructure conversion takes place, in order to be able to also advantageously utilize the advantageous properties already set in the steel sheet in the subsequent, manufactured component part. According to the invention, prior to the manufacture and prior to the assembly of the component parts to create the battery housing, the steel sheets are provided on one or both sides with a zinc-based coat, which provides excellent protection against corrosion and, in association therewith, against rapid rusting-through.

The microstructure can in particular comprise at least 70% of ferrite and martensite, preferably at least 80% of ferrite and martensite, preferably at least 85% of ferrite and martensite, wherein in particular up to 30%, preferably up to 20%, preferably up to 15%, of bainite, pearlite, cementite and/or residual austenite can be present.

Advantageous refinements and variants of the invention emerge from the dependent claims and from the subsequent description.

According to one refinement, the battery housing also comprises an underride guard which is arranged below the base of the box, in particular at a spacing from the base, wherein the underride guard is manufactured from a steel sheet which has a microstructure comprising ferrite and martensite and which is provided with a zinc-based coat on one or both sides. The underride guard can in particular ensure additional protection of the battery modules from foreign bodies penetrating from below if the base of the box is not or cannot be adequately dimensioned. The underride guard is in particular arranged at a spacing from the base of the box, such that, firstly, good utilization of the available installation space for accommodating for example temperature-control means for the purpose of cooling and/or heating the battery modules and/or other means for operating/supplying power to the battery modules can be provided and, secondly, the spacing makes it possible to decelerate penetrating foreign bodies from below, before they can reach, and thereby damage, the sensitive battery modules, which may lead to a critical short circuit and in the worst case to a fire. According to a preferred refinement, in order to be able to be exchanged when damaged but also in order to ensure a certain maintenance possibility from below, the underride guard should be releasably connected to the battery housing. “Releasably” is understood to mean for example mechanical joining methods, such as for example by means of clipping and/or screwing, and/or by means of adhesive bonding. If no (additional) underride guard is present, the base of the box assumes the function of the underride guard. In an alternative refinement, the base can be embodied as a deep-drawn tray.

According to a preferred refinement, the steel sheet has a microstructure comprising at least 60% of ferrite and at least 5% of martensite, wherein up to 35%, in particular up to 30%, preferably up to 25%, of bainite, pearlite, cementite and/or residual austenite can be present. Particularly preferably, the steel sheet has a microstructure comprising 70 to 90% of ferrite and 10 to 30% of martensite, wherein up to 20% of residual austenite can be present. This combination of the microstructure set in the steel sheet allows for a high deformation resistance and at the same time a high coating suitability. Due to the proportion of martensite in the structure up to at most 30%, it is nevertheless possible to cold-form the steel sheet using conventional plant engineering.

According to an alternative refinement, the steel sheet has a microstructure comprising at least 65% of ferrite and martensite, wherein there is 20 to 95% of ferrite and 5 to 80% of martensite, in particular 40 to 80% of ferrite and 20 to 60% of martensite, wherein up to 35%, in particular up to 30%, preferably up to 25%, of bainite, pearlite, cementite and/or residual austenite can be present.

The stated structural proportions in % are based here, with the exception of the figures for the contents of (residual) austenite, which are usually determined by X-ray diffraction and are therefore reported in % by volume, on the area as viewed in a polished section.

According to a further preferred refinement, the steel sheet is provided with a zinc-based coat on one or both sides, said coat also, in addition to zinc and unavoidable impurities, at least one of the elements from the group of aluminum and magnesium. Particularly preferably, the zinc-based coat comprises 0.5 to 4% by weight of aluminum and/or 0.5 to 4% by weight of magnesium, the remainder being zinc and unavoidable impurities, said coat having improved corrosion protection compared with a coat composed of pure zinc. There is a further improvement in the corrosion protection if both aluminum and magnesium are present in the coat, such that, according to a further preferred refinement, the zinc-based coat comprises 1 to 2.5% by weight of aluminum and 1 to 2.5% by weight of magnesium, the remainder being zinc and unavoidable impurities. The improved corrosion protection has the significant advantage that the applied amount, with corrosion protection that is still sufficient, can be of thinner configuration than in the case of conventional (hot-dip galvanized) zinc coats, as a result of which the process reliability during the preferred welding can be improved, which can be crucial for ensuring the tightness of the joining/welded connections in large series manufacturing.

In order to permit sufficient corrosion protection, according to one refinement, the zinc-based coat of the steel sheet for the manufacture of the at least one component part (frame, base, mounting support, cover) has an applied amount of at least 30 g/m² per side on one or both sides on the steel sheet, in particular with an applied amount of 40 g/m² to 90 g/m² per side on one or both sides. If an underride guard is used, according to one refinement, the zinc-based coat of the steel sheet for the manufacture of the underride guard has an applied amount of at least 30 g/m², in particular of at least 60 g/m², preferably of at least 90 g/m² per side on one or both sides on the steel sheet, preferably with an applied amount of 120 g/m² to 300 g/m² per side on one or both sides.

According to one refinement, at least the frame and the base of the box are provided with an additional cathodic dip-paint coat with an applied amount of at least 10 μm per side on one or both sides. The cathodic dip-paint coat generates a barrier and slows down the degradation of the zinc-based coat and can provide particularly effective protection against salt-containing spray water. If an underride guard is used, according to one refinement, the underride guard is provided with an additional cathodic dip-paint coat with an applied amount of at least 15 μm per side on one or both sides, in particular at least 20 μm per side on one or both sides, preferably at least 30 μm per side on one or both sides. After being manufactured as an individual part, the underride guard is additionally coated with a cathodic dip-paint coat, such that a barrier action against the degradation of the zinc-based coat is provided and, as a result, the protection against base metal corrosion is prolonged, particularly if the underride guard is exposed to (salt-containing) spray water. This coat can also be supplemented with further corrosion protection coatings/coats which are subsequently applied.

The underride guard is preferably provided with a higher applied amount of the zinc-based coat, in particular in comparison to the other component parts, since the requirements in terms of corrosion protection for this component are particularly high and, if the underride guard is joined or connected by means of clipping and/or screwing and/or adhesive bonding, the applied amount has no influence on the tightness of the joining connection. If the underride guard is joined or connected by means of welding, it is in particular possible for the applied amounts, described for the base, of the zinc-based coat and of the cathodic dip-paint coat to be used.

According to a second teaching, the invention relates to the use of a battery housing according to one of the preceding refinements for releasable connection to a passenger vehicle, utility vehicle, special vehicle, in particular a bus or omnibus, or a rail-bound vehicle, in particular a tram or passenger-transporting carriage or railcar.

### BRIEF DESCRIPTION OF THE DRAWINGS

The invention is explained in more detail below with reference to drawings. Identical parts are provided with identical reference designations. Specifically:

FIG. 1a) shows a schematic side view of a battery housing,

FIG. 1b) shows a schematic plan view of the battery housing shown in FIGS. 1a), and

FIG. 1c) shows a schematic partial sectional view along the section A-A in FIG. 1b).

### DESCRIPTION OF PREFERRED EMBODIMENTS

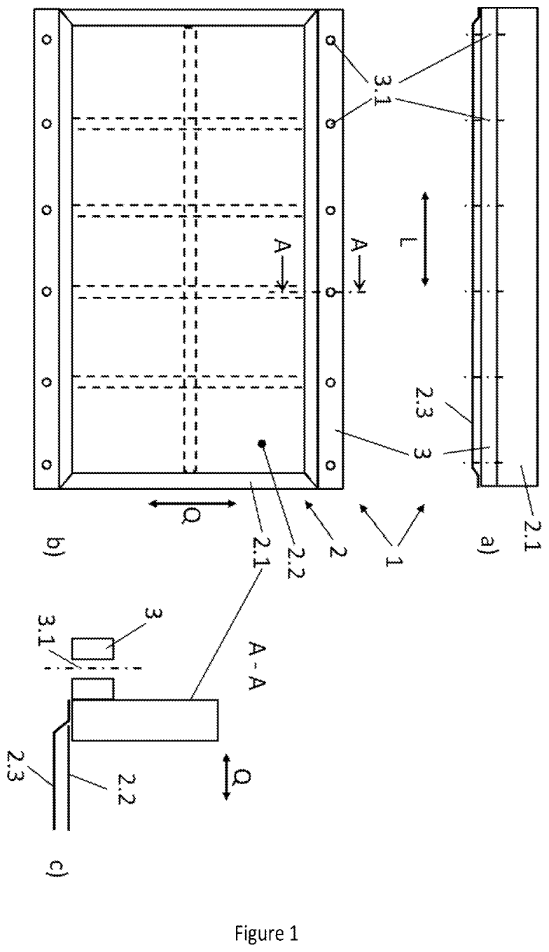

The battery housing (1) for receiving one or more battery modules (not illustrated) can be of differing configuration. According to the invention, the battery housing (1) comprises a box (2) which has a base (2.2) with a frame (2.1), in particular an encircling frame (2.1) in the form of a wall, which defines an interior space for receiving the battery module or modules (not illustrated), and a cover (not illustrated) for closing the box (2). Furthermore, at least one mounting support (3) which is arranged at least in certain portions, on that side of the frame (2.1) which faces away from the interior space, is connected to the frame (2.1) of the box and serves for the releasable connection of the battery housing (1) to a vehicle (not illustrated) via means which are not illustrated, for example screws which can be guided through corresponding openings (3.1). The mounting support (3) is arranged at least in certain portions on the outer side of the frame (2.1) of the box, in particular is substance-to-substance bonded thereto, preferably welded thereto. As shown in FIGS. 1a) and 1b), the mounting support (3) can also be arranged so as to be at least continuous on the two sides of the battery housing (1) along the frame (2.1) in the vehicle longitudinal direction (L). Alternatively or additionally and not illustrated here, the mounting support (3) can also be connected at least in certain portions to the frame (2.1) in the vehicle transverse direction (Q). The mounting support (3) can be dimensioned differently or in accordance with requirements, for example can be formed as an open or closed profile.

The box can be a constructed box (2), meaning that said box is composed of individual components, such as for example of at least one open or closed profile which can be formed in such a way that an encircling frame (2.1) is formed, or preferably of at least four profiles which have an open or closed cross section and are connected to one another in such a way that said profiles form an encircling frame (2.1), and of a plate which is connected to the frame (2.1) and which forms the base (2.2) of the box (2), said box in particular being substance-to-substance bonded. In an alternative refinement (not illustrated), the base of the box can be embodied as a deep-drawn tray.

The battery housing (1) can also comprise an underride guard (2.3) which is arranged below the base (2.2) of the box (2), in particular at a spacing from the base (2.2), see FIGS. 1a) and 1c). In FIG. 1b), shown in dashed line form, at least one reinforcing element, in this embodiment for example exactly one reinforcing element is illustrated, in the vehicle longitudinal direction (L) and/or at least one reinforcing element, in this embodiment for example four reinforcing elements are illustrated, in the vehicle transverse direction (Q) are arranged so as to run in the interior space of the box (2). Said reinforcing elements can be provided as required and thus form compartments for receiving battery modules. In this embodiment, it is for example possible for up to eight battery modules to be received.

According to the invention, at least one of the component parts and/or components, for example the frame (2.1), the base (2.2), the underride guard (2.3), the mounting support (3), the reinforcing element or the reinforcing elements (see FIG. 1b)) or the cover (not illustrated), is manufactured from a respective steel sheet which has a microstructure comprising ferrite and martensite, preferably a microstructure comprising at least 60% of ferrite and at least 5% of martensite, wherein up to 35%, in particular up to 30%, preferably up to 25%, of bainite, pearlite, cementite and/or residual austenite can be present, particularly preferably a microstructure comprising 70 to 90% of ferrite and 10 to 30% of martensite, wherein up to 20% of residual austenite can be present.

The steel sheet for the manufacture of the at least one component part (frame, base, underride guard, mounting support, reinforcing element, cover) is provided, according to the invention, with a zinc-based coat on one or both sides, wherein in particular at least one of the elements from the group of aluminum and magnesium can also be present in the coat in addition to zinc and unavoidable impurities, particularly preferably the zinc-based coat comprises 0.5 to 4% by weight of aluminum and/or 0.5 to 4% by weight of magnesium, the remainder being zinc and unavoidable impurities, further preferably the zinc-based coat comprises 1 to 2.5% by weight of aluminum and 1 to 2.5% by weight of magnesium, the remainder being zinc and unavoidable impurities. The applied amount on the steel sheet or the component part manufactured therefrom is at least 30 g/m² per side on one or both sides on the steel sheet. For the underride guard (2.3), an applied amount of at least 90 g/m² per side can be provided on one or both sides on the steel sheet. Prior to the manufacturing operation to form a component part, the zinc-based coat is applied to the steel sheet, for example in a conventional manner continuously in a strip coating process, preferably in a continuous melt dip coating process.

Preferably, the frame (2.1) or the components for creating the frame (2.1), the base (2.2), the mounting support (3) and the underride guard (2.3) are each manufactured from a steel sheet which has a microstructure comprising ferrite and martensite and which is provided with a zinc-based coat on one or both sides.

In the case of the preferably constructed box (2), the individual components, such as for example the components for creating the frame (2.1), the base (2.2) and optionally the mounting support (3), are connected to one another by a substance-to-substance bond, wherein a welding process is used, in particular a laser welding process or optionally a laser hybrid welding process (with filler material). The combination of microstructure, coat and joining method ensures a high quality of the component parts (2.1, 2.2) which are connected by means of weld seams, and thus the tightness of the battery housing (1). It is thus in particular possible after the box (2) has been completed with or without a mounting support (3) for at least the box (2) to be fed to a cathodic dip painting process, such that at least the frame (2.1) and the base (2.2) of the box (2) are provided with an additional cathodic dip-paint coat with an applied amount of at least 10 μm per side on one or both sides.

The underride guard (2.3) is preferably releasably connected to the battery housing (1) or to the box (2) and is preferably provided with an additional cathodic dip-paint coat with an applied amount of at least 15 μm per side on one or both sides. If no welding is used for connection of the underride guard (2.3), the zinc-based coat and/or the cathodic dip-paint coat can be applied with a high applied amount, in particular with a higher applied amount in comparison to the other component parts (2.1, 2.2, 3), which can lead to particularly good corrosion protection. In order for the connection between the underride guard (2.3) and the box (2) or battery housing (1) to be implemented in a preferably tight manner, the connection region or contact region is additionally provided with adhesive and/or sealing means, such that it is also possible here to ensure water tightness and corrosion protection against premature rusting-through. If the underride guard (2.3) is joined or connected by means of welding, it is in particular possible for the applied amounts, described for the base, of the zinc-based coat and of the cathodic dip-paint coat to be used.

The cover (not illustrated) can be manufactured from a steel sheet having the aforementioned properties. As an alternative, the cover can also be manufactured from another steel material, from a light metal, from a (fiber-reinforced) plastic or else from a mixture thereof in the form of a hybrid. For maintenance purposes, in particular for ensuring the accessibility to the interior space of the box (2), the cover is preferably releasably connected to the box (2).

The invention is not restricted to the embodiment shown, rather the individual features can be combined with one another as desired insofar as this is technically possible.

1. A battery housing for receiving one or more battery modules, in particular for an electrically powered vehicle or a vehicle having a hybrid drive, comprising:
a box having a frame and a base, which provides an interior space for receiving the battery module or modules,
at least one mounting support which is connected at least in certain portions, on that side of the frame which faces away from the interior space, to the frame of the box and which serves for the releasable connection of the battery housing to a vehicle,
a cover for closing the box, wherein at least one of
the frame, the base, the mounting support and the cover of the battery housing is manufactured from a steel sheet which has a microstructure comprising ferrite and martensite, wherein the steel sheet has a microstructure comprising at least 65% of ferrite and martensite, wherein there is at least 20% of ferrite and at least 5% of martensite, wherein up to 35% of at least one of bainite, pearlite, cementite and residual austenite can be present, and which is provided with a zinc-based coat on at least one side.

2. The battery housing as claimed in claim 1, wherein the battery housing also comprises an underride guard which is arranged below the base of the box, wherein the underride guard is manufactured from a steel sheet which has a microstructure comprising ferrite and martensite and which is provided with a zinc-based coat on at least one side.

3. The battery housing as claimed in claim 2, wherein the underride guard is releasably connected to the battery housing.

4. The battery housing as claimed in claim 3, wherein the steel sheet has a microstructure comprising at least 60% of ferrite and at least 5% of martensite, wherein up to 35% of at least one of bainite, pearlite, cementite and residual austenite can be present.

5. The battery housing as claimed in claim 3, wherein the steel sheet has a microstructure comprising 70% to 90% of ferrite and 10% to 30% of martensite, wherein up to 20% of residual austenite can be present.

6. The battery housing as claimed in claim 3, wherein the zinc-based coat also comprises, in addition to zinc and unavoidable impurities, at least one of the elements from the group of aluminum and magnesium.

7. The battery housing as claimed in claim 3, wherein the zinc-based coat comprises at least one of 0.5% to 4% by weight of aluminum and 0.5% to 4% by weight of magnesium, the remainder being zinc and unavoidable impurities.

8. The battery housing as claimed in claim 3, wherein the zinc-based coat has an applied amount of at least 30 g/m² per side on at least one side on the steel sheet.

9. The battery housing as claimed in claim 3, wherein the zinc-based coat has an applied amount of at least 90 g/m² per side on at least one side on the steel sheet.

10. The battery housing as claimed in claim 3, wherein at least the frame and the base of the box are provided with an additional cathodic dip-paint coat with an applied amount of at least 10 μm per side on at least one side.

11. The battery housing as claimed in claim 9, wherein the underride guard is provided with an additional cathodic dip-paint coat with an applied amount of at least 15 μm per side on one or both sides.

12. (canceled)

13. A passenger vehicle comprising the battery housing of claim 1.
